(19) United States
(12) Patent Application Publication
(10) Pub. No.: US 2006/0032022 A1
(43) Pub. Date: Feb. 16, 2006

(54) Tilt hinge and electronic apparatus using the same

(76) Inventor: Toshifumi Minami, Yokohama (JP)

Correspondence Address: NOTARO AND MICHALOS, 100 DUTCH HILL ROAD, SUITE 110, ORANGEBURG, NY, 10962-2100, US

(21) Appl. No.: 11/189,938

(22) Filed: Jul. 26, 2005

(30) Foreign Application Priority Data
Jul. 30, 2004 (JP) JP 2004-224748

(51) Int. Cl. E05D 11/08

(52) U.S. Cl. 16/342

(57) ABSTRACT

The present invention provides a tilt hinge configured so that friction torque members accommodated in a leaf spring housing can be visually checked from outside and an electronic apparatus using the tilt hinge. The tilt hinge pivotally couples a first member to a second member and includes: a holder attached to one of the first and second members and including a leaf spring housing; a shaft attached to the other of the first and second members and rotatably supported by the leaf spring housing; and a plurality of friction torque members accommodated in the leaf spring housing and generating a friction torque when the holder or the shaft rotates. The friction torque members include a friction torque member that is constrained from rotation by the holder and a friction torque member that is constrained from rotation by the shaft. A friction torque is generated between the friction torque member fixed to the holder and the friction torque member fixed to the shaft when the holder and the shaft rotate relatively to each other. The leaf spring housing is provided with a notch portion through which all or some of the friction torque members accommodated in the leaf spring housing can be visually checked from outside.

### BACKGROUND OF THE INVENTION

1. Field of the Invention

The present invention relates to a tilt hinge for pivotally coupling an apparatus main body and a display device of a compact electronic apparatus, such as a notebook personal computer (PC), and to an electronic apparatus using the same.

2. Description of the Related Art

In compact electronic apparatuses, such as notebook PCs, mobile phones, and car navigators, a display device is attached to an apparatus main body in an openable/closable manner. The display device is attached by using a tilt hinge (also called a “tilt mechanism”) so that the display device can be smoothly opened/closed with an adequate torque and that the display device can be held on the main body at an arbitrary angle.

In recent years, compact electronic apparatuses, particularly notebook PCs, are becoming slim and miniaturized. Accordingly, a tilt hinge adaptable to a slim and miniaturized apparatus has been demanded.

In order to satisfy this demand, the applicant of the present application suggested a tilt hinge including friction discs and disc springs in Japanese Patent Laid-open No. 2004-138129. This tilt hinge includes a holder attached to an apparatus main body; a shaft rotatably supported by the holder and attached to a display device; and a plurality of friction torque members including friction discs and disc springs accommodated in a cylindrical leaf spring housing that is integrally provided in the holder. Further, a presser washer for pressing the friction torque members into contact is attached at an end portion of the shaft. Accordingly, the disc springs and the friction discs are pressed into contact, so that a friction force in a thrust direction is generated on contact planes of the friction discs. The friction force generates a friction torque, which holds the display device on the apparatus main body at an arbitrary angle.

The known tilt hinge is capable of generating a necessary friction torque with its small diameter although the tilt hinge is slightly long in its axis direction. Therefore, the tilt hinge is adaptable to a compact electronic apparatus, particularly to a notebook PC which is required to be slim. That is, the tilt hinge is capable of generating a necessary friction torque by using ten or more friction torque members.

However, since the ten or more friction torque members are accommodated in the cylindrical leaf spring housing, the friction torque members accommodated in the leaf spring housing cannot be visually checked during assembling. That is, since the number of friction torque members accommodated in the leaf spring housing is as many as ten or more and a state of the friction torque members accommodated in the leaf spring housing cannot be visually checked, a wrong number or combination of the friction torque members may be accommodated. Further, the wrong number or combination of the friction torque members cannot be easily corrected after assembling, thereby decreasing yields. In order to improve the yields, the friction torque members must be checked one by one during assembling, which needs long time disadvantageously.

### SUMMARY OF THE INVENTION

The present invention has been made to solve the above-described problems and an object thereof is to provide a tilt hinge configured so that friction torque members accommodated in a leaf spring housing can be visually checked from outside and an electronic apparatus using the tilt hinge.

In order to achieve the above-described object, a tilt hinge of the present invention functions to pivotally couple a first member to a second member. The tilt hinge includes: a holder attached to one of the first and second members and including a leaf spring housing; a shaft attached to the other of the first and second members and rotatably supported by the leaf spring housing; and a plurality of friction torque members accommodated in the leaf spring housing and generating a friction torque when the holder or the shaft rotates. The friction torque members include a friction torque member that is constrained from rotation by the holder and a friction torque member that is constrained from rotation by the shaft. A friction torque is generated between the friction torque member fixed to the holder and the friction torque member fixed to the shaft when the holder and the shaft rotate relatively to each other. The leaf spring housing is provided with a notch portion through which all or some of the friction torque members accommodated in the leaf spring housing can be visually checked from outside.

According to the present invention, all or some of the friction torque members accommodated in the leaf spring housing can be visually checked from outside because the notch portion is provided in the leaf spring housing. Therefore, the friction torque members can be arranged in the leaf spring housing while checking the friction torque members during assembling, and thus the number and combination of the friction torque members to be accommodated in the leaf spring housing can be correctly set. Also, assembling can be easily performed while visually checking the friction torque members accommodated in the leaf spring housing. Further, even after the tilt hinge of the present invention has been assembled, the friction torque members accommodated in the leaf spring housing can be visually checked through the notch portion in the leaf spring housing. Thus, the number and combination of the friction torque members can be checked while the tilt hinge of the present invention is being attached to a notebook PC or the like, and thus an apparatus main body and a display device can be reliably coupled to each other so that the both can pivot with a necessary friction torque.

Preferably, in the tilt hinge of the present invention, a cover for covering the notch portion is detachably attached to the leaf spring housing.

Preferably, in the tilt hinge of the present invention, the friction torque members include: a first friction disc which is movable in an axis direction of the shaft and which does not rotate together with the shaft; a second friction disc which is provided next to the first friction disc, which rotates together with the shaft, and which is movable in the axis direction of the shaft; and a pressing unit for pressing at least one of the first and second friction discs to the facing second friction disc and/or the first friction disc.

An electronic apparatus of the present invention includes the tilt hinge of the present invention. According to the present invention, as described above, the friction torque members accommodated in the leaf spring housing can be visually checked through the notch portion in the leaf spring housing. For example, when the tilt hinge of the present invention is to be attached to the notebook PC, the number and combination of the friction torque members can be checked, and thus the apparatus main body and the display device can be coupled to each other so that the both can pivot with a necessary friction torque.

As described above, according to the tilt hinge of the present invention, the friction torque members accommodated in the leaf spring housing can be visually checked through the notch portion in the leaf spring housing. As a result, the number and combination of the friction torque members to be accommodated in the leaf spring housing can be correctly set and assembling can be easily performed.

In the electronic apparatus of the present invention, which uses the tilt hinge of the present invention, the number and combination of the friction torque members can be checked before attaching the tilt hinge to a notebook PC or the like, and thus the apparatus main body and the display device can be coupled to each other so that the both can pivot with a necessary friction torque.

### BRIEF DESCRIPTION OF THE DRAWINGS

FIG. 1 is a perspective view showing an example of a notebook personal computer of the present invention;

FIG. 2 is a side view showing an example of a tilt hinge of the present invention;

FIGS. 3A to 3C show the example of the tilt hinge of the present invention, in which FIG. 3A is a plan view, FIG. 3B is a back view, and FIG. 3C is a front view;

FIG. 4 is a cross-sectional view taken along a line A-A in FIG. 2;

FIG. 5 is a cross-sectional view taken along a line B-B in FIG 2;

FIG. 6 is a side view showing another example of the tilt hinge of the present invention;

FIG. 7 is a perspective view showing an example of a cover of the present invention; and

FIG. 8 is a partial front view showing an example of a holder of the present invention.

### DETAILED DESCRIPTION OF THE PREFERRED EMBODIMENTS

Hereinafter, a tilt hinge of the present invention is described in detail with reference to the attached drawings.

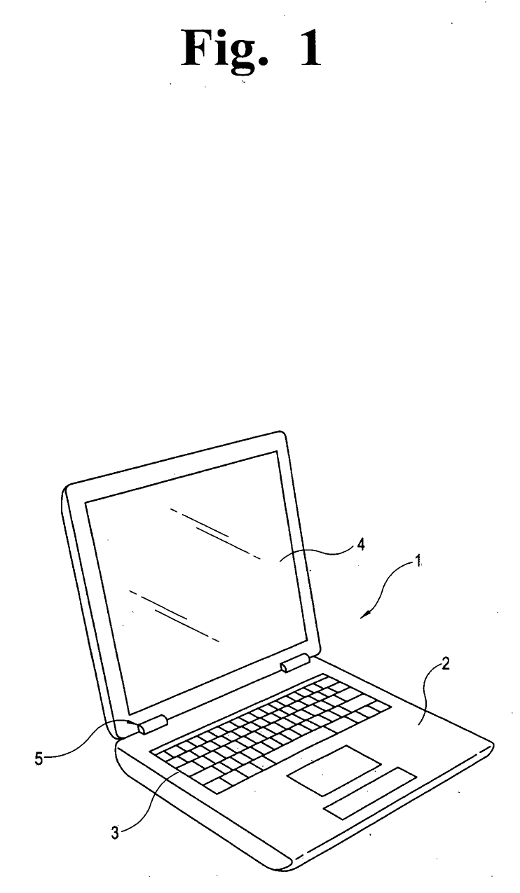

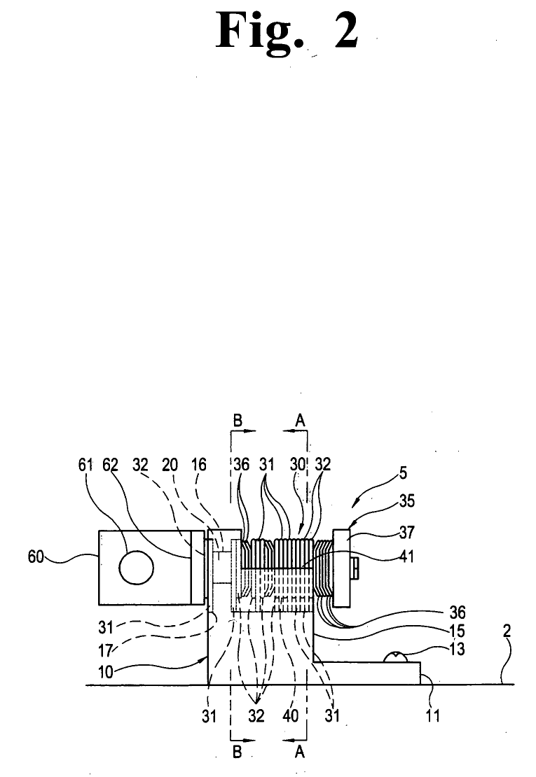

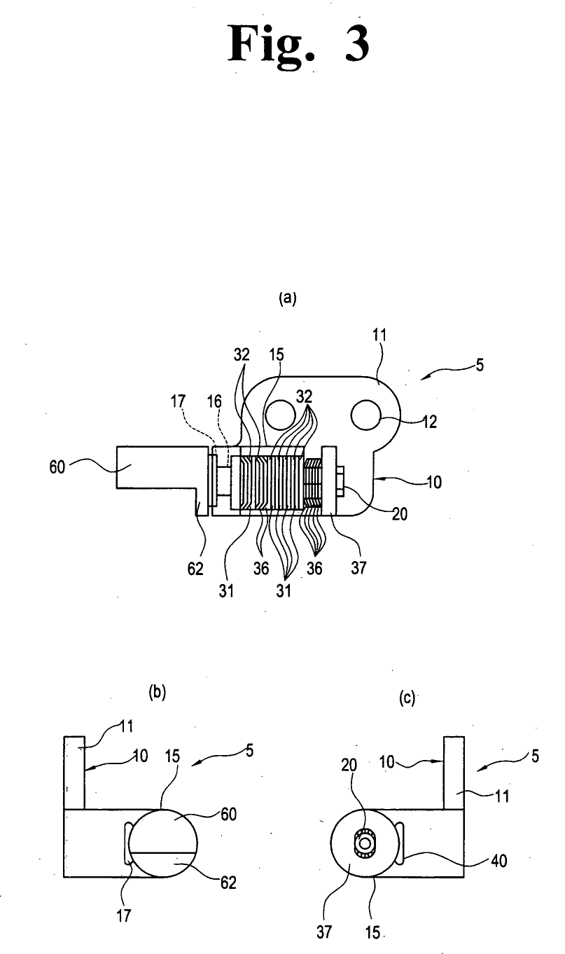

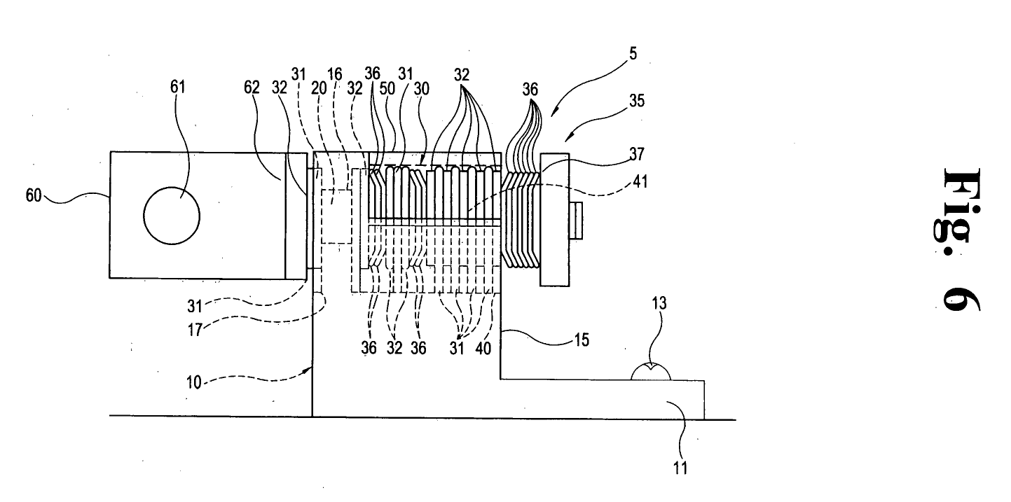

FIG. 1 is a perspective view showing an example of an electronic apparatus of the present invention. FIGS. 2 to 5 are views showing an example of the tilt hinge of the present invention. FIG. 6 is a view showing another example of the tilt hinge of the present invention. The tilt hinge according to the present invention is provided in a compact electronic apparatus, such as a notebook PC, a mobile phone, or a car navigator. In the following example, the tilt hinge according to the present invention is provided in a notebook PC 1, as shown in FIG. 1, but the present invention is not limited to this example. The notebook PC 1 includes an apparatus main body 2 having a keyboard 3, a motherboard, a hard disk drive, and a floppy disk drive. A display device 4 having a liquid crystal panel is attached to the apparatus main body 2 in an openable/closable manner. The display device 4 is attached to the apparatus main body 2 by using tilt hinges 5 (also called a “tilt mechanism”) of the present invention so that the display device 4 can be smoothly opened/closed with an adequate torque and that the display device 4 can be held on the apparatus main body 2 at an arbitrary angle. The number of tilt hinges 5 varies depending on the type of electronic apparatus. In the notebook PC 1 shown in the figure, two tilt hinges 5 are used.

The tilt hinge 5 of the present invention is a hinge for pivotally coupling a first member to a second member. As shown in FIGS. 2 to 6, the tilt hinge 5 includes a holder 10 attached to the apparatus main body 2 as the first member and having a leaf spring housing 15; a shaft 20 attached to the display device 4 as the second member and is rotatably supported by the leaf spring housing 15; and a plurality of friction torque members 30 accommodated in the leaf spring housing 15 and generating a friction torque when the holder 10 or the shaft 20 rotates. The leaf spring housing 15 is provided with a notch portion 41 through which all or some of the friction torque members 30 accommodated in the leaf spring housing 15 can be visually checked from outside. In this case, the holder 10 is attached to the apparatus main body 2 and the display device 4 is attached to the shaft 20. Alternatively, the shaft 20 can be attached to the apparatus main body 2 and the display device 4 can be attached to the holder 10.

The holder 10 is composed of an attaching portion 11 attached to the apparatus main body 2 with an attaching member 13, such as a screw or a bolt; and the leaf spring housing 15 integrally provided on the attaching portion 11. The attaching portion 11 is formed by die-casting zinc into a substantially rectangular platy shape. The attaching portion 11 is provided with one or more attaching holes 12 (two attaching holes 12 in the figure) through which the attaching member 13, such as a screw or a bolt, is inserted. The attaching holes 12 can be provided in the attaching portion 11 in advance or can be provided there before inserting the attaching member 13 therethrough.

The leaf spring housing 15 rotatably supports the shaft 20 and accommodates the plurality of friction torque members 30. The leaf spring housing 15 is integrally disposed upright near a corner of the attaching portion 11 and is provided with a bearing hole 16 having a circular cross section for rotatably supporting the shaft 20. Also, the leaf spring housing 15 is provided with a torque member housing 40 for accommodating the friction torque members 30.

The torque member housing 40 is formed in a size for accommodating two or more friction discs and disc springs included in the friction torque members 30, for example, eighteen friction discs and disc springs in total. The torque member housing 40 is composed of a circular portion 40a which is coaxial with the bearing hole 16 and which has a larger diameter than the bearing hole 16; and a trapezoidal portion 40b having a substantially trapezoidal shape and provided on the attaching portion 11 side with respect to the circular portion 40a.

The notch portion 41, through which part of the friction torque members 30 accommodated in the torque member housing 40 can be visually checked from outside, is provided at a position that is in the circular portion 40a of the torque member housing 40 and that is opposite to the attaching portion 11. The notch portion 41 is a feature of the present invention. That is, the torque member housing 40 provided with the notch portion 41 is formed in a substantially U-shape. The notch portion 41 can be formed so that part of all of the friction torque members 30 accommodated in the torque member housing 40 can be seen from outside, or can be formed so that part of some of the friction torque members 30 accommodated in the torque member housing 40 can be seen from outside. As shown in the figures, when the torque member housing 40 can accommodate eighteen friction discs and disc springs, the notch portion 41 can be formed at a position where sixteen among the eighteen friction torque members 30 are placed. The shape of the notch portion 41 is not limited as long as the friction torque members 30, such as friction discs and disc springs, accommodated in the torque member housing 40 can be seen from outside. The notch 41 is semicircular in the figures, but a circular arc shape may also be adopted.

Further, a cover 50 can be attached to the notch portion 41, as shown in FIG. 6. The cover 50 is not limited, but preferably should be made in accordance with the shape of the notch portion 41, for example, in a semicylindrical shape. An outer diameter of the cover 50 is substantially equal to that of the circular portion 40a of the torque member housing 40, and an inner diameter of the cover 50 is substantially equal to that of the circular portion 40a. By attaching the cover 50 on the notch portion 41, the cover 50 and the notch portion 41 form a cylindrical housing. The cover 50 is made of a synthetic resin or a metallic material.

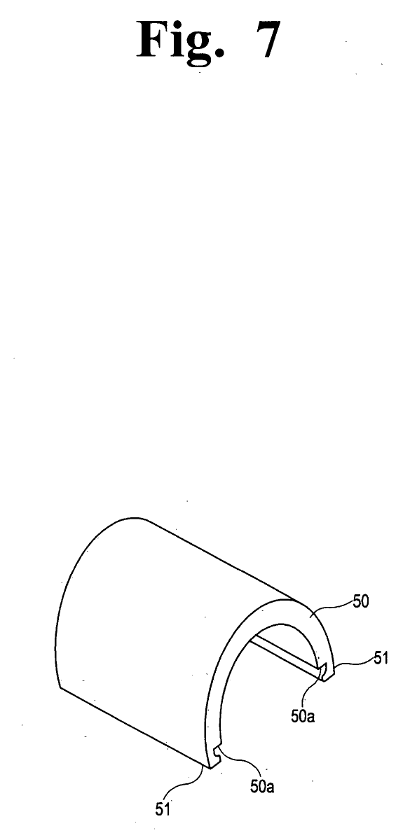

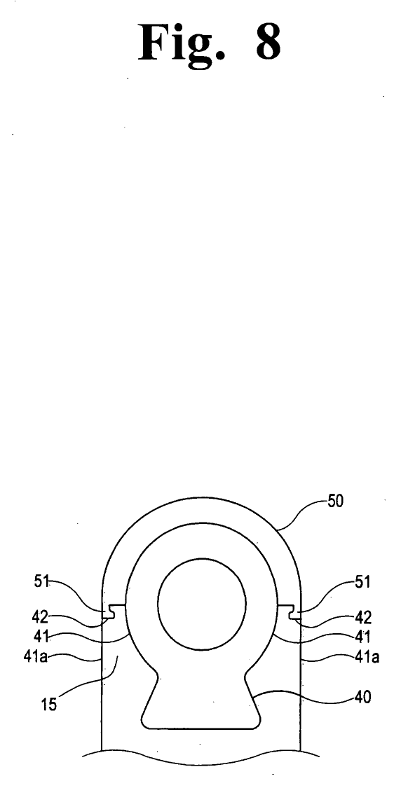

Preferably, the cover 50 should be detachably attached on the notch portion 41. A method for attaching the cover 50 on the notch portion 41 is not limited as long as the cover 50 is detachable. For example, as shown in FIGS. 7 and 8, both contact surfaces 50a of the cover 50 contacting the notch portion 41 may be provided with hooking portions 51, which extend in an orthogonal direction (or substantially orthogonal direction) to the contact surfaces 50a from the contact surfaces 50a, an end portion thereof bending toward an inner surface to form a hook shape. On the other hand, both side portions 41a of the torque member housing 40 provided with the notch portion 41 may be provided with engaging portions 42 engaging with the hooking potions 51. These hooking portions 51 and the engaging portions 42 extend along an entire longitudinal edge of the cover 50 and an entire longitudinal edge of the both side portions 41a, respectively.

Preferably, the hooking portions 51 should be flexible. When the cover 50 is flexible, the cover 50 can be attached on the notch portion 41 by engaging the hooking portions 51 of the cover 50 with the engaging portions 42 by sliding them (sliding method), or by pushing the contact surfaces 50a of the cover 50 against the side portions 41a of the notch portion 41 by using the flexibility of the hooking portions 51 (pushing method). Also, when the cover 50 is flexible, the hooking portion 51 and the engaging portion 42 can be provided at one or more portions of part of the cover 50 and part of the notch portion 41. Alternatively, engaging protrusions can be provided in the cover 50 instead of the hooking portions 51, while providing engaging depressions engaging with those protrusions in the side portions 41a.

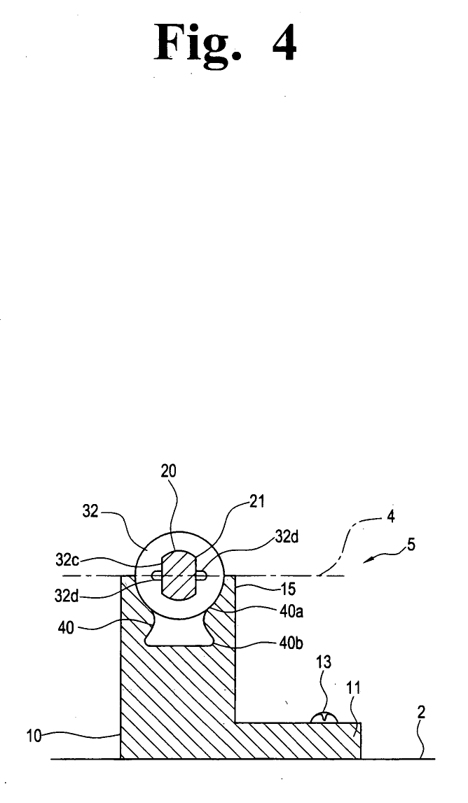

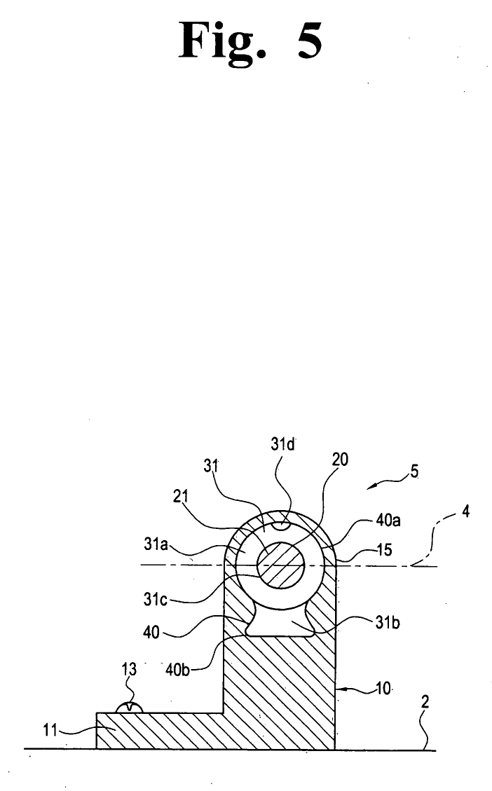

The shaft 20 is rotatably supported by the bearing hole 16 of the leaf spring housing 15, is attached to the display device 4, and is formed by cutting a round bar of SUS (Steel special Use Stainless) or the like. As shown in FIGS. 4 and 5, the shaft 20 has deformed portions 21 at a portion where the friction torque members 30 are mounted and at a portion where the bearing hole 16 is placed. The deformed portions 21 are formed by linearly cutting two circular portions facing each other and have a substantially elliptic cross section (a shape similar to a side view of a Japanese drum). Both end portions of the shaft 20 except the deformed portions 21 are formed to have a circular cross section. A screw groove is spirally formed in a periphery of the both end portions of the shaft 20.

A first end portion of the shaft 20 (an end portion opposite to the torque member housing 40 with respect to the bearing hole 16 when the shaft 20 is supported by the bearing hole 16) is provided with an attaching member 60 to which the display device 4 is attached. The attaching member 60 is not limited, but it is formed in a semicylindrical shape. The attaching member 60 has an attaching hole 61 used to attach the display device 4 and also has a flange portion 62.

The friction torque members 30 generate a friction torque when the holder 10 or the shaft 20 pivots (or rotates). As shown in FIGS. 2 to 5, the friction torque members 30 include first friction discs 31 which are movable in an axis direction of the shaft 20 and which do not rotate together with the shaft 20; second friction discs 32 which are adjacent to the first friction discs 31, which rotate together with the shaft 20, and which are movable in the axis direction of the shaft 20; and a pressing unit 35 for pressing at least one of the first friction disc 31 and the second friction disc 32 to the facing second friction disc 32 and/or the first friction disc 31.

The first friction disc 31 is a washer, an O-ring, or the like made of a hard metallic material which is highly resistant to abrasion. The first friction disc 31 is platy and is a little smaller than an area defined by partitioning a hollow portion in the torque member housing 40. That is, the first friction disc 31 includes a circular disc 31a serving as a friction generating portion and a trapezoidal disc 31b serving as a locking portion, and is formed to be fitted in the torque member housing 40. Further, the first friction disc 31 has a shaft circular hole 31c through which the shaft 20 extends. The shaft circular hole 31c has a diameter that is equal to or slightly larger than the diameter of the circle of the deformed portion 21 of the shaft 20. Preferably, an upper edge (opposite to the trapezoidal portion) of the circular disc 31a of the first friction disc 31 should be provided with an oil reservoir 31d formed by a notch. The position, number, and forming method of the oil reservoir 31d in the first friction disc 31 are not limited to those described in this embodiment. For example, the oil reservoir 31d can be provided at an inner periphery of the shaft circular hole 31c or can be provided as a small hole or a depression in the circular disc 31a.

The second friction disc 32 is also a washer, an O-ring, or the like made of a hard metallic material which is highly resistant to abrasion. The second friction disc 32 is a platy circle having a diameter smaller than that of the circular portion 40a of the torque member housing 40. That is, the second friction disc 32 is formed in a disc shape such that it can be accommodated in the circular portion 40a of the torque member housing 40 with slack. Further, the second friction disc 32 is provided with a shaft deformed hole 32c through which the shaft 20 extends. A dimension of the shaft deformed hole 32c is equal to or slightly larger than that of the deformed portion 21 of the shaft 20 so that the second friction disc 32 can rotate together with the shaft 20. Preferably, the shaft deformed hole 32c should be provided with an oil reservoir 32d.

The pressing unit 35 functions to press at least one of the first friction disc 31 and the second friction disc 32 to the facing second friction disc 32 and/or the first friction disc 31. The pressing unit 35 is not limited as long as it has such a pressing function. The pressing unit 35 is composed of, for example, a resilient member and a fastening member attached to a second end portion of the shaft 20.

The resilient member is not limited, for example, disc springs 36 or spring washers. The disc springs 36 are used in this example. The disc spring 36 bends at its periphery to form a dish shape or a substantially disc shape, and a diameter thereof is smaller than that of the circular portion 40a of the torque member housing 40. The disc spring 36 has a circular shaft hole through which the shaft 20 extends. The number of these disc springs 36, first friction discs 31, and second friction discs 32 to be mounted on the shaft 20 and their position are not limited as long as a friction torque can be generated with a small diameter. For example, the disc springs and friction discs are arranged in the torque member housing 40 in the following order from the side of the bearing hole 16: a first friction disc 31, a second friction disc 32, two disc springs 36, a second friction disc 32, a first friction disc 31, a second friction disc 32, two disc springs 36, a second friction disc 32, a first friction disc 31, a second friction disc 32, a first friction disc 31, a second friction disc 32, a first friction disc 31, a second friction disc 32, a first friction disc 31, and a second friction disc 32. Further, five disc springs 36 can be arranged outside the torque member housing 40.

The fastening member presses the disc springs 36 and the first and second friction discs 31 and 32 so as to bring the first and second friction discs 31 and 32 into tight contact with each other by using a resilient force and so on of the disc springs 36. Accordingly, when the shaft 20 pivots (or rotates), a friction force in a thrust direction is generated between the second friction discs 32 which rotate together with the shaft 20 and the first friction discs 31, thereby generating a friction torque. An example of the fastening member includes a nut screwed at the second end portion of the shaft 20 and a presser washer 37 caulked at the second end portion of the shaft 20. The presser washer 37 is shown in the figures. The presser washer 37 is a steel plate of SUS or the like and is disc-shaped while having a thickness larger than that of the friction discs 31 and 32. The presser washer 37 has a shaft hole through which the shaft 20 extends.

Next, a procedure of assembling the tilt hinge 5 is described.

First, a second friction disc 32 is press-fitted on the flange portion side 62 of the shaft 20, a first friction disc 31 is provided in the depressed portion 17 of the holder 10, and the shaft 20 is inserted through the bearing hole 16 of the holder 10. Then, the first and second friction discs 31 and 32 and the disc springs 36 are arranged around the periphery of the deformed portion 21 of the shaft 20 at a position accommodated in the torque member housing 40, in the following order: a first friction disc 31, a second friction disc 32, two disc springs 36, a second friction disc 32, a first friction disc 31, a second friction disc 32, two disc springs 36, a second friction disc 32, a first friction disc 31, a second friction disc 32, a first friction disc 31, a second friction disc 32, a first friction disc 31, a second friction disc 32, a first friction disc 31, and a second friction disc 32, such that they overlap with each other. In this case, each first friction disc 31 is positioned by inserting the shaft 20 through the shaft circular hole 31c and by sliding the first friction disc 31 on the shaft 20. Likewise, each second friction disc 32 is positioned by inserting the shaft 20 through the shaft deformed hole 32c and by press-fitting the second friction disc 32 to the shaft 20. Each disc spring 36 is positioned by inserting the shaft 20 through the shaft hole and by sliding the disc spring 36 on the shaft 20. Accordingly, eighteen friction torque members 30 in total are arranged around the periphery of the deformed portion 21 of the shaft 20.

Then, the shaft 20 provided with the eighteen friction torque members 30 are mounted on the holder 10. The shaft 20 is mounted on the holder 10 by inserting the first end portion of the shaft 20 through the bearing hole 16 from the torque member housing 40 side and by sliding the eighteen friction torque members 30 around the periphery of the shaft 20 in the torque member housing 40. At this time, since the torque member housing 40 has the notch portion 41, the friction torque members 30 are accommodated in the torque member housing 40 such that part of all or some of the friction torque members 30 can be seen from outside. Therefore, the friction torque members 30 accommodated in the torque member housing 40 can be visually checked. With this configuration, the friction torque members 30 can be put in the torque member housing 40 while checking the friction torque members 30 during assembling, and thus the number and combination of the friction torque members 30 to be accommodated in the torque member housing 40 can be correctly set.

Since the notch portion 41 is provided in the torque member housing 40, edges of the friction torque members 30 may contact an inner wall of the torque member housing 40 when the friction torque members 30 are slid to predetermined positions of the torque member housing 40.

When the cover 50 is to be attached to the notch portion 41 of the torque member housing 40 in the sliding method, the cover 50 can be attached after the shaft 20 has been mounted on the holder 10. When the pushing method is used instead of the sliding method, attachment of the cover 50 to the notch portion 41 is not limited.

Then, five disc springs 36 are mounted from the second end portion of the shaft 20 and are placed next to the outermost second friction disc 32 in the torque member housing 40. After the disc springs 36 have been mounted, the pressing washer 37 is caulked at the second end portion of the shaft 20. Accordingly, the tilt hinge 5 of the present invention is assembled. As described above, the tilt hinge 5 of the present invention is capable of generating a necessary friction torque by accommodating the eighteen friction torque members 30 in the torque member housing 40 with a small diameter, and thus is suitable for a compact electronic apparatus, particularly for the notebook PC 1.

The presser washer 37 is attached so that the disc springs 36 and the first and second friction discs 31 and 32 are pressed into contact and that a friction force in a thrust direction causing a friction torque is generated on contact planes of the disc springs 36 and the first and second friction discs 31 and 32 when the shaft 20 rotates with respect to the holder 10. The friction torque can be arbitrarily varied by varying a caulking force applied to the pressing washer 37. Incidentally, when a nut is used instead of the presser washer, the friction torque can be arbitrarily varied by varying a position of the nut in the shaft 20.

Accordingly, in the tilt hinge 5 of the present invention, the notch portion 41 is provided in the torque member housing 40, and thus the friction torque members 30 accommodated in the torque member housing 40 in the leaf spring housing 15 can be visually checked from outside. As a result, the number and combination of the friction torque members 30 accommodated in the torque member housing 40 can be correctly set, yields can be enhanced, and assembling can be easily performed.

Further, even if the cover 50 is attached to the notch portion 41, the friction torque members 30 can be checked by detaching the cover 50, so that the number and combination of the friction torque members 30 accommodated in the torque member housing 40 can be correctly set and assembling can be easily performed.

For example, the holder 10 of the tilt hinge 5 of the present invention is attached to the apparatus main body 2 of the notebook PC 1 and the display device 4 is attached to the attaching member 60 of the shaft 20. During the attachment, the friction torque members 30 accommodated in the torque member housing 40 can be visually checked because the notch portion 41 is provided in the torque member housing 40 of the leaf spring housing 15. Therefore, the apparatus main body 2 and the display device 4 can be reliably coupled with each other so that the both can pivot with a necessary friction torque. In other words, since the number and combination of the friction torque members 30 accommodated in the torque member housing 40 of the tilt hinge 5 can be visually checked, a tilt hinge 5 having a wrong number or combination of the friction torque members 30 can be replaced with another tilt hinge 5 having a correct number and combination of the friction torque members 30 before coupling the apparatus main body 2 with the display device 4. Therefore, the apparatus main body 2 and the display device 4 can be reliably coupled with each other so that the both can pivot with a necessary friction torque, and thus the yields enhance.

With this configuration, when the display device 4 is opened/closed, the shaft 20 rotates with respect to the holder 10, a friction force in a thrust direction is generated on contact planes of the friction discs 31 and 32, and thus a friction torque is generated. In other words, when the disc springs 36 and the first and second friction discs 31 and 32 are pressed by the presser washer 37 into contact, a resilient force and so on of the disc springs 36 bring the first and second friction discs 31 and 32 into tight contact with each other. When the shaft 20 rotates in this state, a friction force in a thrust direction is generated between the second friction discs 32 rotating together with the shaft 20 and the first friction discs 31, so that a friction torque is generated. As a result, the display device 4 can be smoothly opened/closed with an adequate torque. Further, when opening/closing of the display device 4 is stopped, the display device 4 is held at that position by the friction torque, and thus the display device 4 can be held on the apparatus main body 2 at an arbitrary angle.

Since the friction torque members accommodated in the leaf spring housing can be visually checked, the number and combination of the friction torque members can be correctly set, and a tilt hinge for an electronic apparatus, particularly for a notebook PC, can be provided with enhanced yields.

1. A tilt hinge to pivotally couple a first member to a second member, comprising:
a holder attached to one of the first and second members and including a leaf spring housing;
a shaft attached to the other of the first and second members and rotatably supported by the leaf spring housing; and
a plurality of friction torque members accommodated in the leaf spring housing and generating a friction torque when the holder or the shaft rotates,
wherein the friction torque members include a friction torque member that is constrained from rotation by the holder and a friction torque member that is constrained from rotation by the shaft,
a friction torque is generated between the friction torque member fixed to the holder and the friction torque member fixed to the shaft when the holder and the shaft rotate relatively to each other, and
the leaf spring housing is provided with a notch portion through which all or some of the friction torque members accommodated in the leaf spring housing can be visually checked from outside.

2. The tilt hinge according to claim 1, wherein a cover for covering the notch portion is detachably attached to the leaf spring housing.

3. The tilt hinge according to claim 1, wherein the friction torque members include: a first friction disc which is movable in an axis direction of the shaft and which does not rotate together with the shaft; a second friction disc which is provided next to the first friction disc, which rotates together with the shaft, and which is movable in the axis direction of the shaft; and pressing means for pressing at least one of the first and second friction discs to the facing second friction disc and/or the first friction disc.

4. An electronic apparatus comprising the tilt hinge according to claim 1.
